(19) United States
(12) Patent Application Publication
(10) Pub. No.: US 2017/0350741 A1
(43) Pub. Date: Dec. 7, 2017

(54) Fluid Analysis System

(71) Applicant: DWT Solutions, L.P., a California Limited Partnership, Bakersfield, CA (US)

(72) Inventor: Dan W Marshall, Bakersfield, CA (US)

(21) Appl. No.: 15/173,629

(22) Filed: Jun. 4, 2016

(51) Int. Cl. G01F 1/74; G01F 1/76

(52) U.S. Cl. CPC G01F 1/74; G01F 1/76

(57) ABSTRACT

A fluid analysis system receives a fluid sample having a first liquid component and a second liquid component. The fluid sample is taken from a pipeline through a sampling apparatus to obtain a representative sample of the fluid flowing through the pipe. The representative sample flows into a circulation loop having a circulating pump, a liquid component analyzer, and a cylindrical vessel, with interconnecting piping and actuated valves there between, with the actuated valves and the circulating pump controlled by a digital processor. Once a determination of the relative percentages of the first liquid component and the second liquid component have been determined, the processor stops the circulating pump and activates a piston in the cylindrical vessel which sweeps the cylindrical vessel of any fluid contained in the vessel in preparation of receiving a subsequent fluid sample.

### BACKGROUND OF THE INVENTION

The present invention generally relates to the analysis of a fluid where the fluids may be a mixture of a liquid phase and a gas phase, or where the fluid comprises a liquid phase having two or more liquid components having differing specific gravities or different electrical characteristics, such as resistivity. By way of example, embodiments of the present invention may be utilized to ascertain the flow rate of a flow stream from a hydrocarbon producing well and determine how much of the flow stream is a gas phase, and the quantity of water and oil in the flow stream. As another example, embodiments of the present invention may be utilized to analyze the amount of contaminants, such as water, which may be present in fuel storage systems for aircraft, marine, and motor vehicles.

In general, embodiments of the present invention may be utilized for ascertaining the relative amounts of different components of a liquid, where the different components have either differing specific gravities or different electrical characteristics. Such an analysis has a number of benefits, such as preventing the contamination of engines or power system with a tainted fuel, or ascertaining a relative amount of liquid contaminant present within a particular produced liquid to determine whether the produced liquid is within a desired specification.

### SUMMARY OF THE INVENTION

The presently disclosed apparatus ascertains a relative percentage of water contained in a liquid phase of a fluid sample received from a fluid source. Embodiments of the disclosed apparatus may include a sampling probe which acquires a representative sample of the fluid flowing through a delivery line.

The fluid sample may comprise a liquid phase and a gas phase, while the liquid phase comprises different components, such as an oil, fuel oil, or other liquid component and a water component, where the liquid components either have different specific gravities or electrical characteristics. Gas phase separation may occur prior to introducing the fluid sample into the disclosed apparatus. Alternatively, embodiments of the present invention provide for gas phase separation to be achieved through the system itself.

In one embodiment of the disclosed systems, a pipe receives the fluid to be analyzed. A representative sample of the fluid is acquired from a sampling apparatus which has one or more probes installed through a wall of the pipe. The sample of the fluid flows into the sampling probe when a valve hydraulically connected to the outlet of the sampling probe opens. A circulating pump has an inlet hydraulically connected to the sampling probe. The circulating pump receives the sample of the fluid and discharges the sample to a cut analyzer connected to the pump discharge. The cut analyze ascertains the relative percentages of the liquid components in the first portion of fluid as it is circulated through the analyzer.

The sampling apparatus will typically be downstream of an inline mixer. The sampling probe(s) of the sampling apparatus is installed through a wall of the pipe through which the fluid to be sampled is flowing. In one embodiment of the sampling apparatus, a first probe is inserted through a wall of the pipe downstream of an inline mixer. The first probe comprises a first shaft having a first terminal end and a first outlet end. A portion of the first shaft spans substantially across the internal diameter of the pipe. The first shaft further has an internal axial passage which extends from adjacent the first terminal end through to the first outlet end. The first shaft also has a first upstream face facing towards the inline mixer and a first downstream face facing away from the direction of the downstream mixer. The first upstream face of the sampling probe has a solid wall and the first downstream face has plurality of spaced-apart radial slots extending through from the first downstream face to the first axial passage.

The sampling apparatus may also have a second probe installed through a wall of the pipe downstream of the outlet of the inline mixer. The second probe will substantially have the same structural elements as described above for the first probe. The first probe and the second probe may be installed such that the first probe and second probe are perpendicular to one another. With this configuration, a sample taken by the sampling apparatus will be representative of the fluid flowing through the pipe at the time of the sampling.

As the sample of fluid is circulated through the system, it flows through a liquid component analyzer, through a vessel inlet and into a cylindrical vessel which is hydraulically connected to the liquid component analyzer. The liquid phase of the sample, and any remaining entrained or dissolved gas, flows out through an outlet of the cylindrical vessel, such that a circulation loop is defined as the fluid sample is circulated by the circulating pump through the liquid component analyzer and the cylindrical vessel.

As the sample is circulated, any gas phase components which come out of solution are vented out of the cylindrical vessel through a gas outlet. The sample is circulated through the circulation loop until such time as the liquid component analyzer reports consistent relative percentages of the liquid components, as determined by specified tolerance values inputted into a processor which controls the system. Once the liquid component analyzer reports consistent relative percentages of the respective liquid components (e.g., water and oil) according to the pre-determined values, the processor stops the circulating pump and a piston within the cylindrical vessel displaces all fluids contained within the cylindrical vessel in preparation for receipt of the next sample.

The piston is moveable from a first position to a second position, wherein substantially all fluids contained within the cylindrical vessel are displaced from the cylindrical vessel as the piston moves from the first position to the second position. A first sensor is connected to the cylindrical vessel, where the first sensor ascertains when the piston is in the first position. A second sensor ascertains when the piston is in the second position.

In this embodiment, the fluid is swept from the sampling cylinder as the piston moves from a “raised” position to a “lowered” position. Fluid is discharged from the cylindrical vessel as the piston moves from the raised to the lowered position. It is to be noted that, as utilized within this disclosure, the terms “raised,” “lowered,” “top,” “bottom,” etc., are made with respect to the orientations of the piston and cylinder as depicted in the figures herein. However, the operation of the system is not dependent upon the components of the system being oriented as depicted in the drawings. Therefore, the use of the terms “raised,” “lowered,” “top,” “bottom,” etc. should be understood to be consistent with the a “raised” piston being in the initial position before it sweeps a cylinder and a “lowered” piston being in its final position after it has swept the cylinder and cleared all fluid from the cylinder.

It is to be noted that the presently disclosed invention can utilize many different devices as the liquid component analyzer for the determination of the relative amounts of the liquid components, so long as the liquid components have some characteristic, such as different electrical properties, specific gravities, etc. which may be utilized to distinguish the respective liquid components. The presently disclosed invention improves the accuracy of these devices by providing a sample, on the fly at real-time conditions, where the sample is essentially gas free and, optionally, heated for those applications which require the liquid component distribution to be performed at a specified temperature, such as the API criteria for determination of water cut. The inventor herein has found that PHASE DYNAMIC water cut analyzers, which utilize the difference between the electrical characteristics of the different liquids are acceptable for use for many applications, including the determination of the relative percentages of water and oil in the fluid sample, but other analyzers may be utilized as well.

A vacuum pump may be connected to the cylindrical vessel to facilitate gas separation as the sample flows through the circulation loop. Alternatively, the vacuum may be applied from an external source, such as a field gas collection system or vapor recovery system.

Gas which has been evacuated from the cylindrical vessel may be directed to a gathering line and measured through a gas flow meter, and if desired, a gas chromatograph to ascertain the gas stream constituents as discussed below. The gas flow meter may provide output to the processor as well.

The piston utilized in the cylindrical vessel may be configured with a piston head and seals which efficiently sweep the cylinder clear of all fluids contained within the cylinder, such that there is little or no mingling of samples as each sample is processed through the system. The cylinder wall may be lined with a material which is non-stick and capable of receiving high temperature fluids.

The sample may be heated within the cylindrical vessel to further effect separation of the gas phase and liquid phase and separation of the liquid phase components. The heating means will typically be of the electrical resistance type, such as heat blanketing wrapped about the cylindrical vessel. However, process heat might also be utilized with the cylindrical vessel with a heat exchanger receiving process fluids such as steam or heated liquids. For such embodiments, the cylindrical vessel may be connected to one or more heat sensors which detect, or provide output to the processor which may be utilized to regulate the temperature of the fluid contained within the system according to pre-set values.

It should be understood that all sensors utilized with embodiments of the device may be located outside of the cylindrical vessel, which greatly facilitates maintenance and repair. In addition, the sensors may be of the type which provide output signals compatible for receipt as input to a digital processor for either data collection or control purposes.

The piston in the cylindrical vessel may be actuated by a variety of actuation devices, including a low voltage servo motor. This motor may be actuated by the digital processor described above, such that a piston operating within the cylindrical vessel operates according to conditions which may be detected by, among other things, the position sensors and temperature sensors described above, as well as flow sensors which may be utilized in the system. Among other possible input received by the processor and in addition to the other devices listed herein, the processor may also receive input from other end devices utilized in the processing of the fluid, such as pressure transducers detecting the pressure of the cylindrical vessel or other process vessels, water salinity from the liquid component cut analyzer, gas flow rates from the gas flow meter, and other devices utilized in the applicable industry.

The processor may therefore be utilized to manage the flow of a sample through the system, determining the time required to contain a satisfactory liquid sample for the relative amount of liquid components, as well as controlling piston position, heat, etc. of the system. In these embodiments, the processor controls a plurality of solenoid operated valves to manage the flow of fluids through the system.

### BRIEF DESCRIPTION OF THE DRAWINGS

FIG. 1 shows a general schematic of an embodiment of the analyzing apparatus.

FIG. 2 shows an embodiment of a analyzing cylinder, piston and related components which may be used with the apparatus.

FIG. 3 shows a process flow diagram for an embodiment of the present invention.

FIG. 4 shows a perspective view of an embodiment of a cylinder which may be utilized in embodiments of the present invention.

FIG. 5 shows a perspective view of an embodiment of a piston which may be utilized in embodiments of the present invention.

FIG. 6 shows a side view of the piston of FIG. 5.

FIG. 7 shows a sectional view taken along line 7-7 of FIG. 6.

FIG. 8 shows a portion of an embodiment of the analyzing apparatus showing the location where a sample may be extracted.

FIG. 9 shows a close-up view of a static mixer and a sampling apparatus.

FIG. 10 shows an end view of the static mixer and sampling apparatus of FIG. 9.

FIG. 11 shows a perspective view of a sampling probe or quill which may be utilized in embodiments of the presently disclosed analyzing apparatus.

FIG. 12 shows a side view of the sampling probe of FIG. 11, showing a detailed view of the slots.

FIG. 13 shows a front view of the sampling probe of FIG. 11.

FIG. 14 shows as section view taken along line 14-14 of FIG. 13.

FIG. 15 shows a top view of the sampling probe of FIG. 11.

FIG. 16 exemplifies an operator screen of a digital processor which provides data display and/or control of embodiments of the disclosed apparatus.

### DETAILED DESCRIPTION OF THE EMBODIMENTS

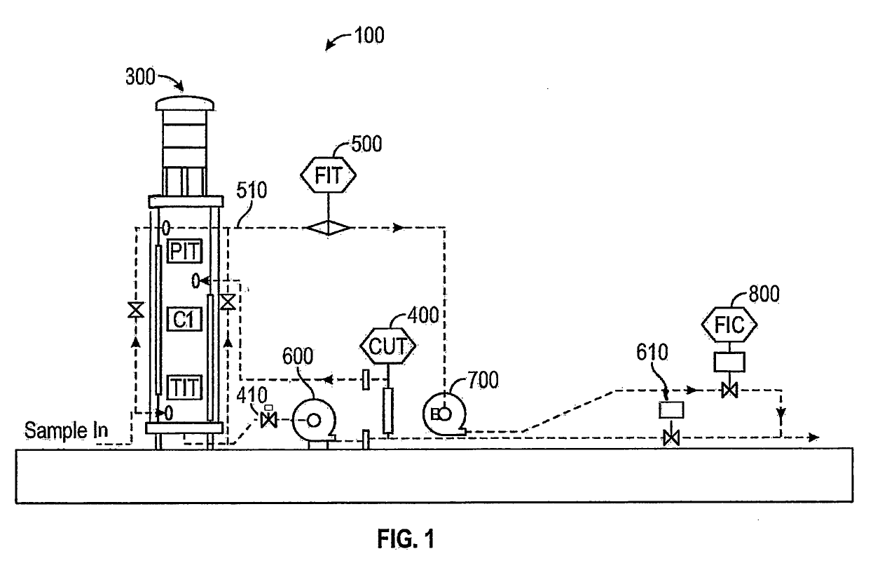

FIG. 1 schematically depicts an embodiment of the presently disclosed fluid analysis system 100 according to the present invention. A fluid sampling system 200 for obtaining a representative fluid sample from pipeline 10 is described in further detail below. With respect to the fluid analysis system depicted in FIG. 1, the major components of this embodiment include cylindrical vessel 300, liquid component analyzer 400, gas flow meter 500, circulating pump 600, gas compressor 700, and flow control valve 800. A digital processor 1000, not shown in FIG. 1, provides, among other things, control of the process flow of the analysis system and reporting of the analysis results. It is to be appreciated that the components of the production analysis system 100 may be relatively small, fitting within an instrument cabinet or mounted on a transportable skid for easy movement between locations. Flow volumes may be relatively small and interconnecting piping may be ½ inch stainless steel tubing.

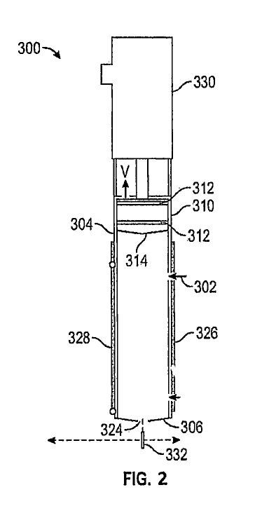

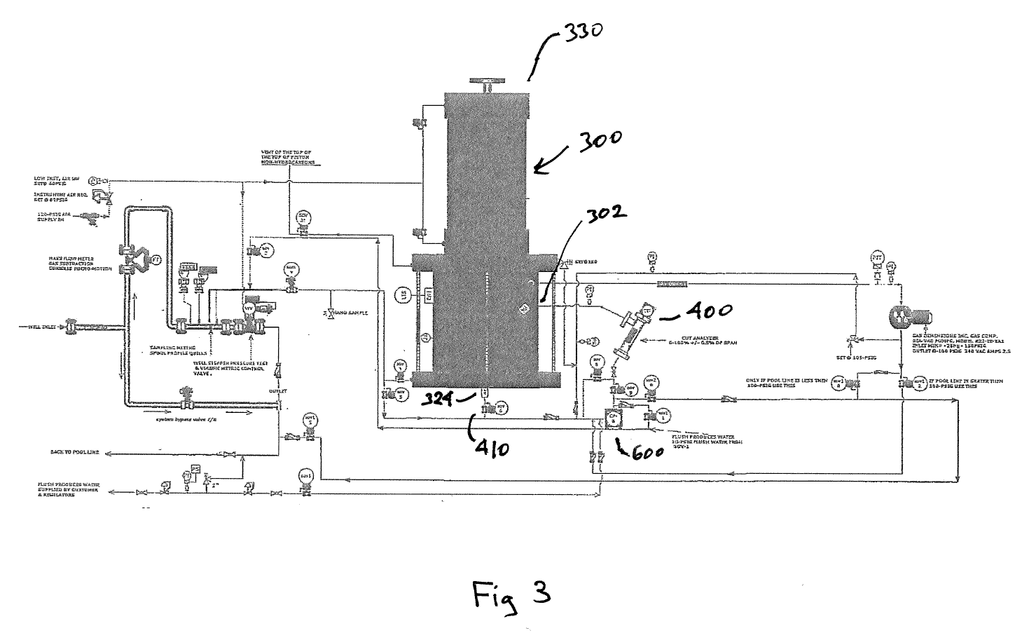

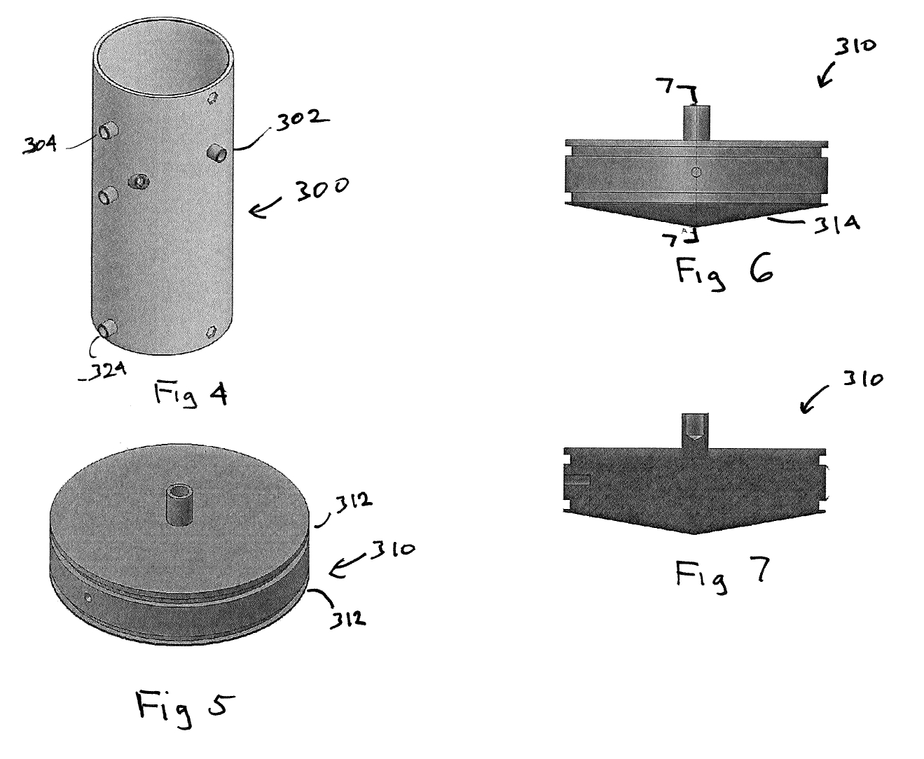

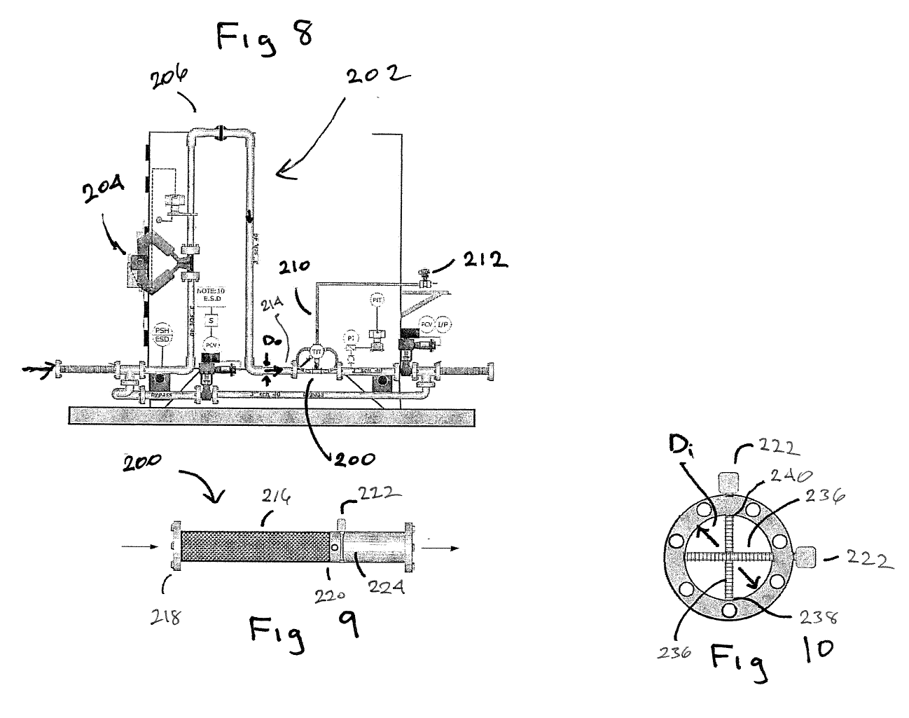

FIG. 2 schematically depicts an embodiment of a cylindrical vessel 300 which may be utilized with the present system. The cylindrical vessel may be fabricated from 316 stainless steel. The size of the vessel may change depending upon a variety of factors, such as the gas-liquid ratio and viscosity of the test fluid (i.e., the fluid to be analyzed) or whether the test fluid is an emulsion. For test fluids requiring little residence time in the system, such as fluids which have already been degasified and/or containing non-emulsified liquid components or liquid components with significant variations in specific gravity and/or electrical characteristics, the cylindrical vessel may be relatively small, perhaps having an outside diameter of 3 inches with an overall height (or length) of 36 inches, resulting in an approximate volume of 1.5 gallons of fluid. However, where the two liquid components have similar specific gravity, such as with low gravity crude and produced water, a larger cylindrical vessel will normally be desired. A cylindrical vessel for these applications may have a diameter and height which provides a volume of 10 gallons of fluid or greater.

The internal surface of cylindrical vessel 300 may be coated with a non-stick liner suitable for high temperature surface, which facilitates the removal of sample fluid from the cylindrical vessel 300. The cylindrical vessel 300 should be rated for a minimum of 300 psig, assuming a vacuum of 2.0 inches of water is applied to the vessel. The cylindrical vessel 300 may be equipped with a rupture disc (not shown). Cylindrical vessel 300 receives a fluid sample through inlet 302. Vent 304 provides for the outflow of any gas phase components into a gas collection line 510 which may be transmitted to a gas flow meter 500.

Cylindrical vessel 300 has a piston 310 which may have o-ring seals 312. The o-ring seals 312 may be configured as double seals having an adjustable wear backing ring. Piston 310 may have a head portion 314 which has a profile which mates with the profile of the bottom 306 of cylindrical vessel 300, thereby providing for greater sweep efficiency of the cylindrical vessel 300 by piston 310. Piston 310 may be actuated by a low voltage servo motor 330.

The cylindrical vessel 300 may be heated to promote separation of any free gas, and also to allow the liquid phase components to reach a desired temperature, such as the American Petroleum Institute (“API”) standard temperatures for testing water cut through liquid component analyzer 400. The means for heating the sampling cylinder 300 may comprise an electrical resistance heating element, such as in a heat blanket 326 or it utilize process heat in conjunction with a heat exchanger receiving process fluids such as steam or heated liquids. The cylindrical vessel 300 may be connected to one or more heat sensors 328 which detect the internal temperature of the cylindrical vessel 300.

Cylindrical vessel 300 has an outlet 324 which is hydraulically connected to the intake of circulating pump 600, which flow from the outlet controlled by solenoid operated valve 410. A sampling probe 332 may detect flowing liquid temperature at outlet 324 and provide this information to processor 1000.

The fluid sample is circulated through liquid component analyzer 400 which determines the relative percentages of the first liquid component and the second liquid component in the circulating liquid phase. Liquid component analyzer 400 may provide data output to processor 1000. Once stable and consistent relative liquid component percentages are ascertained by the liquid component analyzer 400, the circulation of the liquid phase through the circuit may be ceased by the issuance of instructions to a motor controller for circulating pump 600. Once circulation has stopped, automated valve 410 is closed by instructions from processor 1000 and automated valve 610 is opened by instructions from processor 1000 for return of the liquid phase components to a group line. Upon the completion of the liquid component analysis, piston 310 may be actuated by servo motor 330 to clear any remaining fluid inside cylindrical vessel 300 for discharge from the disclosed fluid analysis system 100 and discharge from the system as desired.

Appropriate interconnect piping for the fluid analysis system 100 is one half-inch stainless steel tubing with fittings, utilizing stainless steel ASCO solenoid and check valves. The fluid analysis system 100 may be configured as a compact skid package to facilitate transportation and installation of the unit. For example, the entire system may be configured into a unit 40 inches long by 40 inches tall by 30 inches wide.

FIGS. 8 through 15 depicts an embodiment of a fluid sampling system 200 which may be utilized in combination with the presently disclosed fluid analysis system 100. The fluid sampling system 200 provides representative fluid samples to the system 100. FIG. 8 depicts a piping configuration 202 which may be utilized in conjunction with embodiments of the fluid analysis system 100. This piping configuration may include a mass flow meter 204 set within a bypass loop 206 into which the fluid sampling system 200 may be installed, where the sample is taken of fluid flowing through pipe 214.

Representative fluid samples are received through sampling line 210 by the operation of actuated valve 212 which allows flow of the sample into the fluid analysis system 100. Pipe 214 has a fluid flowing through it as depicted by the arrows. Pipe 214 has an internal diameter Dᵢ. The sampling system 200 may be fabricated into the pipe 214 as a segment of the piping. Sampling system 200 has an inline mixer 216. Inline mixer 216 is a static mixer which allows for continuous blending of fluids within pipe 214 utilizing the energy of the flow stream to generate the mixing. Inline mixer 216 has an inlet 218 and an outlet 220.

The fluid sampling system 200 has a probe 222 which is installed into a tee fitting or alternatively into a welded or threaded reinforced branch fitting, such as a WELDOLET or THREADOLET (not shown) which provides access through a wall 224 of the piping segment. The probe 222 is installed immediately adjacent to the outlet 220 of the inline mixer 216. The reinforced branch fitting or tee fitting may have threads which receive threads 226 of the head 228 of the probe 222. Head 228 may have attached a fitting 230 having ½ inch MNPT (male national pipe thread) with a flared bevel on the opposite end of the threads 232 which make up into internal threads 234 at the top of head 228. External threads 226 of head 228 may likewise be ½ inch

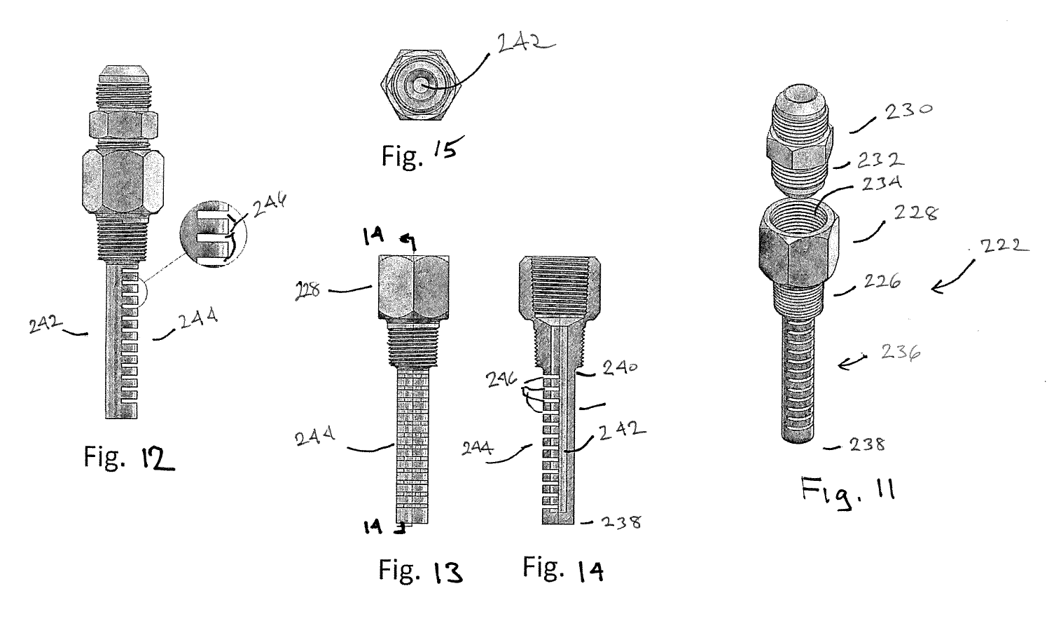

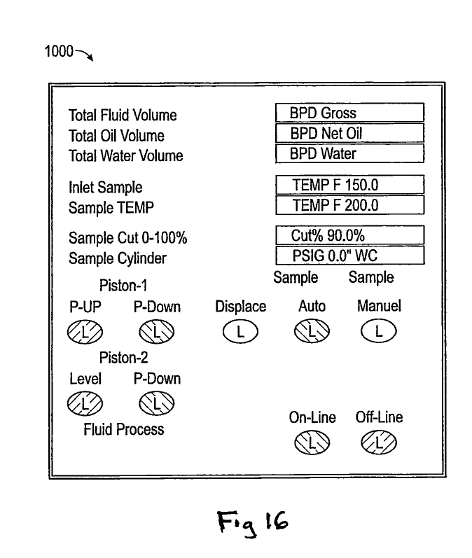

Probe 222 has a shaft 236 which depends from head 228. The shaft 236 has a terminal end 238 and an outlet end 240. Terminal end 238 may be plugged as shown in FIG. 14, but an axial passage 242 extends from a point immediately adjacent to the plugged end of terminal end 238 through to the outlet end 240 and out of head 228. As shown in FIG. 10, the portion of the shaft 236 extending from terminal end 238 to outlet end 240 spans substantially across the internal diameter Dᵢ of the pipe 214.

Shaft 236 has an upstream face 242 which faces toward the outlet 220 of inline mixer 216. As shown in FIG. 12, the upstream face 242 of shaft 236 is solid, i.e., the upstream face 242 has no openings penetrating into axial passage 242. Opposite upstream face 242 is downstream face 244. Downstream face 244 has a plurality of spaced-apart radial slots 246. Slots 246 may extend approximately through half of shaft 236. Each slot may be spaced 0.2 inches from an adjacent slot. Radial slots 246 penetrate through the wall of shaft 236 to provide a flow path to axial passage 242, such that a portion of a representative fluid sample enters into shaft 236 only by passing through slots 246 in the downstream face 244.

As shown in FIG. 10, the fluid sampling system 200 may have a second probe 222 which is identical to the first probe described above. As further shown in FIG. 10, the first probe 222 and the second probe 222 may be configured to be perpendicular to one another.

With the probe(s) 222 configured and installed as described above, a fluid sample taken from pipe 214 will flow into the axial passage 242 of shaft 236 through spaced-apart radial slots 246 on the downstream face 244 of the shaft, with the fluid sample taken along the entire diameter of pipe 214. If two probes 222 are configured as shown in FIG. 10, the sample is being drawn from across a vertical and horizontal axis, each extending across nearly the entire internal diameter of the pipe 214 thereby collecting a sample along the entire flow profile, which is particularly useful for two phase fluid flow, such as a gas phase and a liquid phase, or in fluid flows where gravitational separation of individual components may occur, such as with some hydrocarbon fluids produced from different wells, or from different producing zones of a single well, where the hydrocarbons are combined into a single pipeline.

Because the radial slots 246 are on the downstream face 244 of the shaft 236, the sample will be acquired from fluid which has already flowed past the shaft and the radial slots will not be subject to plugging from any solids which may be entrained in the flowing fluid. This configuration further facilitates backwashing of the radial slots 246 when cleaning of the probe 222 is required.

The dimensions of sampling probe 222 may vary according the size of pipe 214. By way of example only, the total length of probe 222, without fitting 230, may be 4¼ inches, with shaft 226 having a length of 2½ inches extending below threads 226 of head 228. Shaft 226 may have an outside diameter of ½ inch. Radial slots 246 may extend into shaft 226 by ¼ inch, or half-way through the diameter. Radial slots 246 may be spaced by 0.190 inches from center to center—i.e., each slot spaced less than 0.2 inches from an adjacent slot.

FIG. 16 schematically shows a display from a digital processor 1000 which may be utilized with embodiments of the fluid analysis system 100, specifically in oil well applications. As exemplified by the schematic of FIG. 16, the processor display may show a calculated gross daily production rate, daily oil rate, and water rate, which would be calculated by the processor based upon input received from a load cell or other device. The processor 1000 may also display the respective percentages of the liquid components, such as the water cut, for a given sample, the temperatures of the fluid sample at the inlet of the device and the temperature of the liquid sample as it flows to the liquid component analyzer 400. The processor may also display the current pressure and/or vacuum within the cylindrical vessel 300. Control of the fluid analysis system 100 may also be performed at controls on the digital processor 1000, where the controls provide for manual or automated operation of the system, or allowing the system to be placed offline. The digital processor 1000 may provide a display which shows the status of the various components, such as the position of the piston 310 inside the cylindrical vessel 300.

It is to be appreciated that the cycling of the fluid analysis system 100 is controlled by the processor 1000 based upon real time conditions observed through the various sensors and controlled through the actuation of various end devices as determined appropriate by the processor. Thus, operation of the cylindrical vessel 300 0 and the various other control devices may be varied according to the observed conditions and as desired for the particular application or process. For example, in an oil field application, the timing of the sampling and volume of produced fluid tested for a particular well may be adjusted as necessary to obtain consistent and representative information.

While the above is a description of various embodiments of the present invention, further modifications may be employed without departing from the spirit and scope of the present invention. Thus the scope of the invention should not be limited according to these factors, but according to the following appended claims.

What is claimed is:

1. A system for ascertaining a relative percentage of a first liquid and a relative percentage of a second liquid contained in a liquid phase of a fluid, the system comprising:
a pipe which receives the fluid;
a sampling apparatus comprising a first sampling probe extending through a wall of the pipe, the first sampling probe hydraulically connected to a first valve, where upon the opening of the first valve a first portion of the fluid enters the first sampling probe;
a circulating pump having a pump inlet and a pump discharge, wherein the inlet is hydraulically connected to the first sampling probe and receives the first portion of the fluid upon the opening of the first valve;
a liquid component analyzer connected to the pump discharge, the liquid component analyzer capable of ascertaining the relative percentages of the first liquid and of the second liquid in the first portion of fluid;
a cylindrical vessel having a vessel inlet hydraulically connected to the liquid component analyzer, and a vessel outlet, wherein a circulation loop is defined by the interconnected circulating pump, the liquid component analyzer and the cylindrical vessel;
a piston disposed within the cylindrical vessel, wherein, upon completion of ascertaining the relative percentages of the first liquid and the second liquid in the first portion of fluid, the piston is moveable from a first position to a second position, wherein substantially all of any fluid contained within the cylindrical vessel is displaced from the cylindrical vessel as the piston moves from the first position to the second position; and
a first sensor connected to the cylindrical vessel which ascertains when the piston is in the first position and a second sensor which ascertains when the piston is in the second position.

2. The system of claim 1 wherein the first sampling probe comprises a first shaft, wherein the first shaft comprises a first terminal end and a first outlet end, wherein a portion of the first shaft spans substantially across the internal diameter of the pipe, the first shaft further comprising a first axial passage extending from adjacent the first terminal end through to the first outlet end, the first shaft further comprising a first upstream face facing an incoming flow of the fluid and a first downstream face in opposite relation to the first upstream face, wherein the first downstream face comprises a first plurality of spaced-apart radial slots extending through from the first downstream face to the first axial passage, wherein the first portion of the fluid enters the first plurality of spaced-apart radial slots, enters the first axial passage and exits the first outlet end.

3. The system of claim 1 wherein the cylindrical vessel comprises a heater for heating the fluid.

4. The system of claim 1 wherein the piston is actuated by a low voltage servo motor.

5. The system of claim 1 further comprising a processor which receives input from the first sensor and the second sensor.

6. The system of claim 5 wherein the processor provides output signals which cause the piston to move back and forth between the first position and the second position.

7. The system of claim 6 wherein the piston moves back and forth between the first position and the second position by a low voltage servo motor which receives the output signals from the processor.

8. The system of claim 1 wherein the first valve is a solenoid operated valve which is instructed to open by a processor after any fluid contained in the cylindrical vessel is displaced from the cylindrical vessel.

9. The system of claim 1 wherein the cylindrical vessel comprises a gas outlet for discharging any gas phase present in the first portion of the fluid.

10. The system of claim 9 wherein a vacuum pump is hydraulically connected to the gas outlet.

11. A system for ascertaining a relative percentage of a first liquid component and a relative percentage of a second liquid component contained in a liquid phase of a fluid, the system comprising:
a pipe which receives the fluid;
a first sampling probe extending through a wall of the pipe, the first sampling probe hydraulically connected to a first solenoid operated valve, where upon the opening of the first solenoid operated valve a first portion of the fluid enters the first sampling probe;
a circulation loop comprising a circulating pump, a liquid component analyzer, and a cylindrical vessel wherein a second solenoid operated valve controls flow from the circulating pump into the liquid component analyzer, and a third solenoid operated valve controls flow form the cylindrical vessel into the circulating pump, wherein the circulation loop is hydraulically connected to the first sampling probe and receives the first portion of the fluid upon the opening of the first valve;
wherein the liquid component analyzer is capable of ascertaining the relative percentages of the first liquid component and the second liquid component in the first portion of fluid as the first portion of fluid is circulated through the circulation loop;
a piston disposed within the cylindrical vessel, wherein, upon completion of ascertaining the relative percentages of the first liquid component and of the second liquid component, the piston is moveable from a first position to a second position, wherein substantially all of any fluid contained within the cylindrical vessel is displaced from the cylindrical vessel as the piston moves from the first position to the second position; and
a first sensor connected to the cylindrical vessel which ascertains when the piston is in the first position and a second sensor which ascertains when the piston is in the second position.

12. The system of claim 11 further comprising a processor which receives input from the first sensor and the second sensor.

13. The system of claim 12 wherein the processor provides output signals which cause the piston to move back and forth between the first position and the second position.

14. The system of claim 12 wherein the processor provides instructions to the first solenoid operated valve, the second solenoid operated valve, and the third solenoid operated valve when to open and close.

15. A system for ascertaining a relative percentage of a first liquid component and a relative percentage of a second liquid component contained in a liquid phase of a fluid, the system comprising:
a pipe which receives the fluid;
a first solenoid operated valve hydraulically connected to the pipe where upon the opening of the first solenoid operated valve a first portion of the fluid is drawn into a cylindrical vessel by a circulating pump;
a liquid component analyzer hydraulically connected to the cylindrical vessel, the liquid component analyzer capable of ascertaining the relative percentages of the first liquid component and of the second liquid component in the first portion of fluid;
a circulation loop wherein the first portion of the fluid is circulated by the circulating pump through the liquid component analyzer and the cylindrical vessel, the circulation loop comprising a second solenoid operated valve which, upon opening, the first portion of the fluid is circulated through the circulation loop;
a piston disposed within the cylindrical vessel, wherein, upon completion of ascertaining the relative percentages of the first liquid component and of the second liquid component in the first portion of fluid, the piston is moveable from a first position to a second position, wherein substantially all of any fluid contained with the cylindrical vessel is displaced from the cylindrical vessel as the piston moves from the first position to the second position;
a first sensor connected to the cylindrical vessel which ascertains when the piston is in the first position and a second sensor which ascertains when the piston is in the second position; and
a processor which receives input from the first sensor and the second sensor and which provides instructions to the first solenoid operated valve and the second solenoid operated valve to open and close.

16. The system of claim 15 wherein the pipe which receives the fluid comprises a mass flow meter which transmits a mass flow rate to the processor.

17. The system of claim 15 wherein the piston moves back and forth between the first position and the second position by a low voltage servo motor which receives the output signals from the processor.

18. The system of claim 15 wherein the cylindrical vessel comprises a gas outlet for discharging any gas phase present in the first portion of the fluid.

19. The system of claim 18 wherein a vacuum pump is hydraulically connected to the gas outlet.

20. The system of claim 15 wherein the cylindrical vessel comprises a heater for heating the fluid.
